(19) United States
(12) Patent Application Publication
(10) Pub. No.: US 2002/0169623 A1
(43) Pub. Date: Nov. 14, 2002

(54) Online creation of tickets for ticketed events

(76) Inventors: Nicholas J. Call, Sandy, UT (US); Spencer Taylor, Salt Lake City, UT (US)

Correspondence Address: R Burns Israelsen, WORKMAN, NYDEGGER & SEELEY, 1000 Eagle Gate Tower, 60 East South Temple, Salt Lake City, UT, 84111, US

(21) Appl. No.: 09/852,506

(22) Filed: May 10, 2001

(51) Int. Cl. G06F 17/60; B42D 15/00; B42D 15/10

(52) U.S. Cl. 705/1; 283/72

(57) ABSTRACT

Methods and systems for creating online tickets enable a user to purchase a ticket over the Internet and to redeem the ticket for admission at a ticketed event. Barcodes are printed on the tickets and contain unique authentication information. Dual barcoding enables authentication information of the ticket to be read when one of the barcodes is damaged or cannot be read. A copy of the authentication information is stored in a database and is used to verify the authenticity of a ticket when it is presented for redemption at a ticket event. Authenticity of the ticket is verified by comparing authentication information on the ticket with authentication information accessed from the database. To discourage counterfeiting, the tickets contain transparent images that when photocopied become opaque and prevent a ticket from being redeemed.

### BACKGROUND OF THE INVENTION

1. The Field of the Invention

The present invention relates to methods and systems for the online creation of tickets. More particularly, the present invention relates to methods and systems for creating and distributing uniquely identifiable tickets that are received over the Internet and that can be authenticated and redeemed for admission to ticketed events.

2. The Prior State of the Art

It is commonly known that a ticket must be presented and redeemed in order to gain admission to a ticketed event. It is also widely known that if an event is one of great demand, it may not be possible to wait until the last minute to purchase a corresponding ticket, otherwise the event may be sold out. To ensure that a ticket is obtained, particularly for events of great demand, some patrons purchase tickets well in advance of the date of the event. In some extreme circumstances, patrons even camp out hours or days in line to increase their chances of getting a desired ticket. This, however, is a great inconvenience for many people, particularly parents and professionals who cannot afford to sacrifice the time that is necessary to camp out, or to even wait in line to purchase a ticket on a different day or time than the time that is scheduled for the event.

When it becomes too difficult and inconvenient to purchase tickets, a business may loose sales because some patrons will decide it is not worth the hassle and inconvenience to purchase a ticket. One way to retain patrons and to minimize the hassles of purchasing tickets is to allow patrons to purchase tickets over the telephone. This, however, is also problematic. In particular, when more than one patron decides to purchase a ticket at the same time, it is likely that the phone lines will get backed up and that at least one of the patrons will be put on hold, resulting in further delay, frustration and inconvenience. This is particularly true when there are a limited number of telephone operators to answer incoming calls.

Another problem with selling tickets over the telephone is that operators are typically not available at all hours of the day and night, and are often not available when it is most convenient for some people to purchase a ticket, such as when a patron arrives home after work. Although it would be desirable to allow patrons to purchase tickets at any time, it can be too costly to operate a ticket call center at all times of the day and night. Another disadvantage of telephone ticket sales is that sometimes it is difficult for a patron to communicate with a ticket sales operator, such as when there is a bad phone line connection or when the operator lacks adequate communication skills. Furthermore, when a patron has a choice of seats to choose between, it can be difficult and frustrating for a patron to make an informed decision regarding what seat to choose because of the difficulty in comprehending exactly where a seat is located without seeing a visual representation of the seat location in a corresponding arena, stadium, auditorium, or other venue.

One way to overcome these problems is to enable patrons to purchase tickets over the Internet. With appropriate software and a suitably configured Web page, a business can sell tickets online at any time of the day or night, without requiring the services of a dedicated telephone operator. The bandwidth capabilities of the Internet also enable several patrons to purchase tickets at the same time. Yet another benefit is that the Internet can enable a patron to see where available seats are located by presenting a visual image of the event venue and seating area.

One problem with online ticketing, however, is that online tickets are easy to counterfeit and difficult to authenticate. This is particularly a problem for expensive and ‘in demand’ ticketed events, in which there is a greater incentive for counterfeiters to make fraudulent tickets. An online ticket can be counterfeited, for example, by making duplicate photocopies of the ticket. Counterfeit tickets can also be produced by printing several tickets from a single electronic image of the ticket.

In view of the foregoing, there is a need in the art for a new method and system for creating tickets that can be purchased by the public in a convenient manner. It would be particularly useful to enable tickets to be purchased over the Internet in a manner that would make it easy to authenticate the tickets, while discouraging counterfeiting. Any improvement in the method of selling tickets can have great benefit for many entities involved in the purchase and sale of tickets for ticketed events, particularly for event sponsors and patrons.

### SUMMARY AND OBJECTS OF THE INVENTION

The present invention relates to systems and methods for creating online tickets for ticketed events. More particularly, the present invention enables a user to purchase a uniquely identifiable ticket over the Internet that can be used for admission to a ticketed event. The systems and methods of the invention discourage counterfeiting and facilitate authentication of the purchased ticket.

The invention enables a user to select and purchase a desired ticket from an online ticket menu that is displayed on the user's computer system. Ticket selections, personal information, and financial information are collected from the user over a secure sockets layer (SSL) Internet connection. Once a desired ticket is selected and purchased, an electronic image of the ticket is displayed on the user's computer system and can be printed for use. The ticket contains ticketed event information, uniquely identifiable ticket authentication information, and a counterfeit deterrent. Ticket information is displayed on the ticket in barcode format and is also stored in a database associated with the server system.

An event computer system verifies the authenticity of a ticket by reading the ticket authentication information located on the printed ticket and by comparing it with ticket information that is accessed from the database. If a valid printed ticket is photocopied, then an opaque counterfeit deterrent is be displayed on the photocopied image of the printed ticket, making the photocopied ticket void and unredeemable for admission.

One particular benefit of the embodiment just described, is that it enables a user to conveniently purchase a ticket over the Internet at any time of the day or night, and to print the purchased ticket from home, while preserving the integrity of the ticketing process by deterring counterfeiting of the purchased ticket.

Additional objects and advantages of the invention will be set forth in the description which follows, and in part will be obvious from the description, or may be learned by the practice of the invention. The objects and advantages of the invention may be realized and obtained by means of the instruments and combinations particularly pointed out in the description. These and other objects and features of the present invention will become more fully apparent from the following description, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is an illustration of one suitable environment for practicing the methods and systems of the invention for creating tickets online, the environment includes a user computer system, a server system, an event computer system, the Internet and a financial services system;

FIG. 2 is an illustration of one embodiment of a ticket that is created according to the systems and methods of the invention for creating tickets online, the ticket includes ticketed event information, authentication information, and a counterfeit deterrent;

FIG. 3 is a flow chart illustrating one embodiment of the invention for creating tickets online;

FIG. 4 is an example of a ticket purchasing menu that is displayed on a user interface of the user computer system for enabling a user to select and purchase a ticket that is created online according to the systems and methods of the invention; and

FIG. 5 is a block diagram showing increased detail of the components that make up a ticket creation module of the server system of FIG. 1.

### DETAILED DESCRIPTION OF THE PREFERRED EMBODIMENTS

The present invention relates to methods and systems for creating tickets online. In particular, the present invention enables a user to purchase uniquely identifiable tickets over the Internet. The tickets can be authenticated and redeemed for admission to a ticketed event. The systems and methods of the invention also discourage counterfeiting of the tickets that are created online.

In one embodiment, the invention enables a user to select and purchase a desired ticket from an online ticket menu that is displayed on the user's computer system. Ticket selections, personal information, and financial information are collected from the ticket menu over a secure sockets layer (SSL) Internet connection. Once a desired ticket is selected and purchased, an electronic image of the ticket is displayed on the user's computer system and can be printed for use. The ticket contains ticketed event information, uniquely identifiable ticket authentication information, and a counterfeit deterrent. Ticket information is displayed on the ticket in barcode format and is also stored in a database associated with the server system.

An authentic printed ticket is redeemable for admission at a corresponding ticketed event. An event computer system verifies the authenticity of the printed ticket by reading the ticket authentication information located on the printed ticket and by comparing it with ticket information that is accessed from the database. If a valid printed ticket is photocopied then an opaque counterfeit deterrent will be displayed on the photocopied image of the printed ticket, making the photocopied ticket void and unredeemable for admission.

One particular benefit of the embodiment just described, is that it enables a user to conveniently purchase a ticket over the Internet at any time of the day or night, and to print the purchased ticket from home, while preserving the integrity of the ticketing process by deterring counterfeiting of the purchased ticket.

Embodiments of the invention, as described herein, may comprise a special purpose or general-purpose computer comprising various computer hardware, including, but not limited to display monitors, keyboards, mouse, magnetic storage drives, and printers. Embodiments may also include computer-readable media having computer-executable instructions or data structures stored thereon. Such computer-readable media can be any available media that can be accessed by a general-purpose or special-purpose computer. By way of example, and not limitation, such computer-readable media can comprise RAM, ROM, EEPROM, CD-ROM or other optical disk storage, magnetic disk storage or other magnetic storage devices, or any other medium which can be used to store the desired executable instructions or data structures and which can be accessed by a general-purpose or special-purpose computer.

When information is transferred or provided over a network or other communications connection to a computer, the computer properly views the connection as a computer-readable medium. Thus, such a connection is also properly termed a computer-readable medium. Combinations of the above should also be included within the scope of computer-readable media. Computer-executable instructions comprise, for example, instructions and data which cause a general-purpose computer, special-purpose computer, or special-purpose processing device to perform a certain function or group of functions. The computer-executable instructions and associated data structures represent an example of program code means for executing the steps of the invention disclosed herein.

The invention will be described in the general context of computer-executable instructions, such as program modules, being executed by a computer. Generally, program modules include routines, programs, objects, components, data structures, or the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

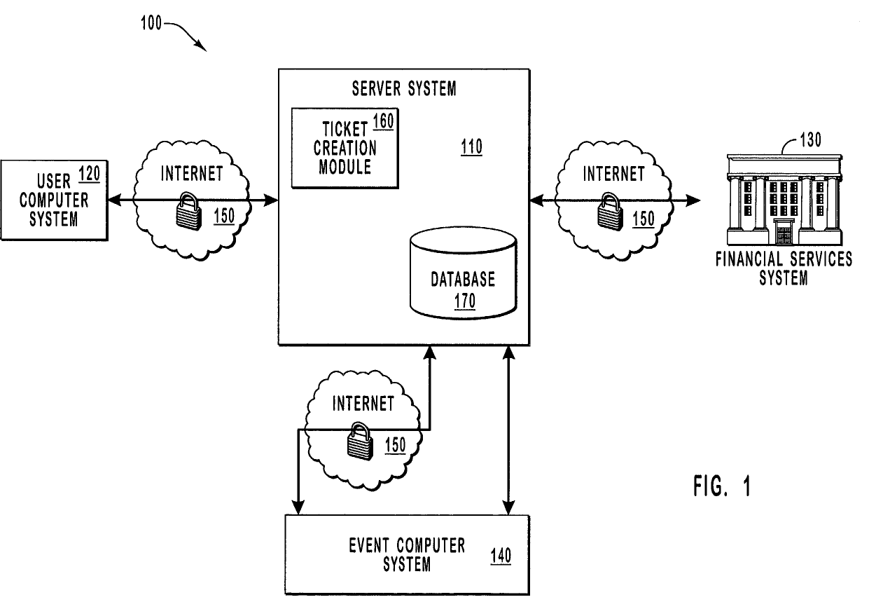

Turning now to FIG. 1, one suitable environment 100 for practicing the invention is illustrated. As shown, a server system 110 is connected to a user computer system 120, a financial services system 130, and an event computer system 140 through the Internet 150. User computer system 120 is operated by a user accessing the server system 130 to purchase a ticket online. The server system 130 includes a ticket creation module 160 for creating a ticket according to the invention and a database 170 for storing ticket information that is subsequently accessed by the event computer system 140. Database 170 also stores user account information so that a user does not have to reenter account information when making a subsequent ticket purchase. The financial services system 130 verifies a user's financial information and enables a user to transact the purchase of a ticket online. The event computer system 140 transmits relevant ticket and event information to the server system 110 so that it can be presented to a user making a ticket purchase. The event computer system 140 also authenticates purchased tickets so that they can be redeemed for admission to a corresponding event. Each of these systems and components of these systems will be discussed in more detail throughout.

The event computer system, the user computer system, and the financial services system are all centrally connected to the server system, preferably over a network connection, such as a wide area network (WAN) connection, or a local access network (LAN) connection. In one preferred embodiment the network connection is a secure sockets layer (SSL) Internet connection for ensuring the privacy and security of data transmissions between the systems. It should be appreciated, however, that neither a SSL connection or any other type of network connection is required to enable the methods and systems of the invention to authenticate tickets that have been created online. In one embodiment, for example, a connection between the server system 110 and the event computer system 140 is not a network connection, but rather a courier type connection 180, in which data is transmitted from the server system 110 to the event computer system 140 via a tangible medium, such as a magnetic or floppy diskette.

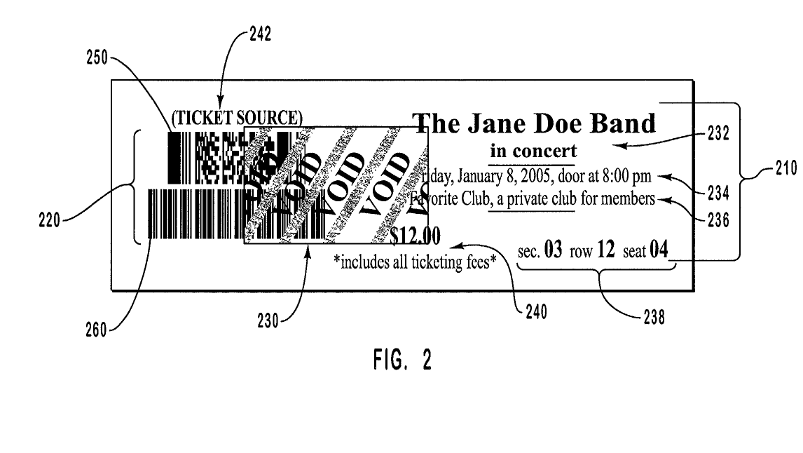

FIG. 2 illustrates one embodiment of a ticket that can be created according to the methods and systems of the invention. The ticket includes ticketed event information 210, authentication information 220, and a counterfeit deterrent 230. The ticketed event information can include any information that is relevant to the ticketed event, such as the name 232 of the performance or event 234, the date of the event, the location of the event 236, the seat location 238, unless it is a general admission ticket, and the price of the ticket 240. The ticket may also include other information, such as ticket source information 242, advertisements, coupons, endorsements, etc.

The authentication information 220 is presented in barcode format. Although in the present embodiment the authentication information 220 is displayed in two barcodes, a PDF-417 barcode 250 and a Code 39 barcode 260, it should be appreciated that a variety of barcodes and barcode formats can be used without departing from the spirit of the present invention. One advantage of using PDF-417 and Code 39 barcodes 250, 260 is that they are very common, making scanners and readers of these types of barcodes fairly inexpensive and easy to obtain.

PDF-417 is a high density, two-dimensional barcode that essentially comprises several stacked lower level barcode sets. Accordingly, PDF-417 barcodes can hold large quantities of information. For example, a single PDF-417 barcode can contain the entire Gettysburg Address. Code 39, also known as code 3 of 9, is a very common barcode language which can represent alphanumeric characters of varying length. Code 39 barcodes are commonly used to mark consumer products that are sold over the counter. PDF-417 and Code 39 barcodes can easily be read with a barcode scanner. Methods and apparatus for reading barcodes are well known in the art.

One benefit of using two barcodes to display authentication information 220, as shown in FIG. 2, is that a copy of the authentication information 220 can be independently contained in each of the barcodes 250, 260. This is beneficial because it enables the authentication information 220 to be read from one of the barcodes even if the other barcode has become damaged or if a scanner becomes incapable of reading one of the two types of barcodes 250, 260.

It should be appreciated, however, that authentication information 220 does not have to be displayed completely or independently within each of the barcodes 250, 260. It is possible, for example, for authentication information 220 to be divided between the barcodes 250, 260. This can be useful for minimizing the required size of the barcodes 250, 260, while also enabling the barcodes 250, 260 to collectively display increased amounts of authentication information 220.

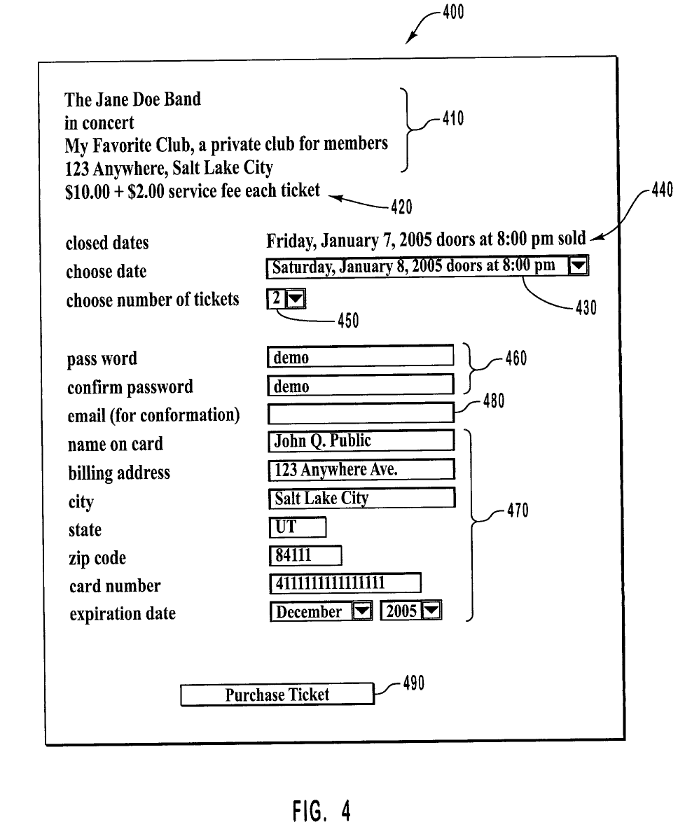

Authentication information 220 can include any type of information that enables a ticket to be authenticated. In one embodiment of the invention, authentication information 220 includes an event identification number, a randomly generated number, and an incremental ticket count number. In other embodiments, authentication information 220 also includes user-defined input and personal verifiable information, such as a user's personal identification number, email address, age, address, phone number, driver's license number, etc. Authentication information 220 can also include information that the event sponsor may find useful and wishes to track, such as advertising source codes. Each of these types of authentication information 220 will be described in greater detail in reference to FIG. 4.

Counterfeit deterrent 230 is useful for discouraging certain types of counterfeiting. Counterfeit deterrent 230, in the present embodiment, includes a transparent image that is printed directly onto the ticket. The image may comprise any words, such as “VOID”, or any graphics, such as diagonal lines. The image may also comprise a grayscale background. Although the image is substantially transparent, it is detected when photocopied. A photocopy image of the counterfeit deterrent 230 is opaque or substantially opaque and is more visible that the transparent image, and at least distinguishable from the transparent image. The transparent image is not shown in the drawings. Instead, counterfeit deterrent 230 is illustrated dark and opaque to illustrate how a photocopy image of the counterfeit deterrent 230 may appear on a photocopied ticket. As shown, repeated use of the word “VOID” and diagonal lines are plainly apparent. When counterfeit deterrent 230 is positioned over the barcodes 250, 260, it can also prevent a photocopied ticket from being scanned. It should be appreciated, however, that even when the ticket is not scanned, the counterfeit deterrent 230 enables an event ticket collector to easily identify and deny tickets that have been photocopied.

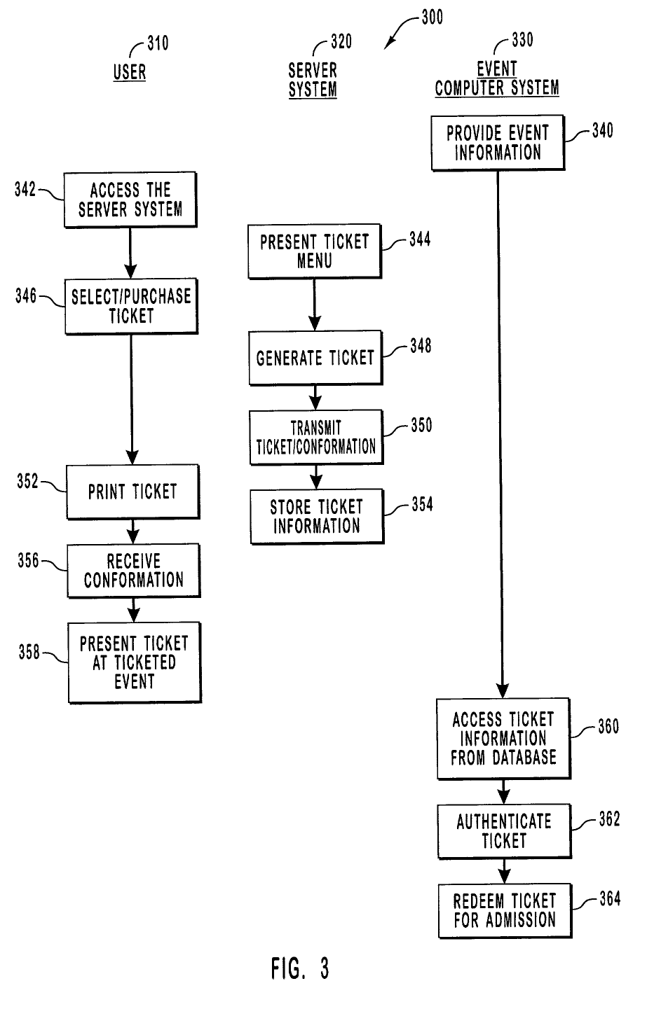

One method of the invention for creating, authenticating, and redeeming a ticket that is purchased online can be accomplished by performing the acts shown in flow chart 300 of FIG. 3 and will be generally described in reference to FIGS. 1-5.

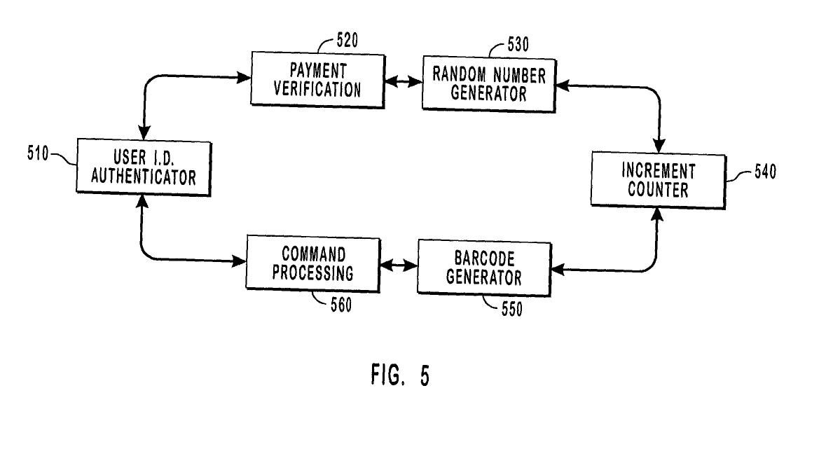

Because each figure number is incorporated into individual references, i.e., reference 342 appears in FIG. 3 and reference 540 appears in FIG. 5, the specific figure number may be inferred and therefore may not be explicitly identified in the discussion that follows. It should also be noted that while the steps or acts of FIG. 3 are shown sequentially, there is no requirement that the acts be completed in the exact order shown. For example, the act of transmitting a ticket to the user can occur subsequent to the act of storing ticket information in a database. The user may also receive confirmation of a ticket purchase before a ticket is printed and before ticket information is stored in a database.

As shown in FIG. 3, flow chart 300 is broken down between acts performed by a user 310, by the server system 320, and by the event computer system 330. Initially, in step 340, event information is provided to server system 330, which is the same as server system 110. Upon receiving the event information, server system 110 stores a copy of the event information in database 170 and prepares the event information in a menu format for display to the user 310. Event information may include the name of a performance or event, the date of the event, the location of the event, the number of available seats, and the location of available seats, if applicable. Event information can also include ticket price, advertising codes, and any other relevant information. Advertising codes enable an advertiser to receive credit for purchases that are made, in part, due to an advertisement. For example, if a Web page or print media advertises an event and a ticket is purchased, in part, due to that advertisement, a ticket purchaser can identify the advertisement source and a record can be made that associates the ticket purchase with the corresponding advertisement. This is useful for compensating advertisers and for determining what advertisements are effective. By entering an appropriate advertisement source, a user can also benefit from any ticket purchase discounts associated with that advertisement, if any.

A user wishing to purchase a ticket, either independently or because of advertising, accesses the server system 110, step 342, with user computer system 120, preferably over a SSL Internet connection. The connection is established when the user 310 enters a Uniform Resource Locator (URL) associated with a Web page of the server system 110 or by following an Internet link to an associated Web page of the server system 110. Internet links and methods for linking Web pages are well known in the art. The user 310 may also be required to enter an account name and/or password to access the server system.

Once a connection is established between the user computer system 120 and the server system 110, the user 310 is presented with a ticket menu, step 344. The ticket menu may comprise a single Web page or may include several linked Web pages having ticket menu information. A user 310 navigates through the ticket menu to select and purchase a desired ticket or tickets.

FIG. 4 illustrates one embodiment of a ticket menu 400 that is displayed on a user interface of the user computer system 120 for enabling a user 310 to select and purchase a desired ticket according to step 346. As shown in the present embodiment, event information 410 is already displayed, having been selected earlier on a previous menu display page or having been provided as a result of a user following an Internet link advertising the event. Menu 400 also displays ticket price and service fee information 420 associated with purchasing the designated ticket online.

The user 310 selects the date and time of the event that is desired from pulldown menu 430. Dates and times 440 that are sold out or closed to sale are also displayed, making it immediately apparent when an event showing is unavailable, without requiring the user 310 to first search through pulldown menu 430. It should be appreciated that this is an advantage over the prior art of selling tickets. In particular, it is an advantage over having to wait in line or on hold before discovering that a particular showing is sold out or otherwise unavailable. Ticket menu 400 also enables a user to select and purchase multiple tickets at the same time. To designate how many tickets the user 310 wishes to purchase, the user 310 selects a desired quantity from pulldown menu 450.

In another embodiment, when an event is not a general admission event, the ticket menu 400 can also include a map that displays available seat locations and corresponding ticket prices. It should be appreciated that this is also an improvement over the prior art of trying to comprehend where a specific seat is located from a telephone menu or even from an operator's explanation over the telephone.

In some instances it is useful for the user to enter personal verifiable information that can be recited or verified at a ticketed event to facilitate authentication of the purchased ticket and to discourage counterfeiting. This will be discussed in more detail in reference to act 362. Personal verifiable information, which can include a password, email address, personal identification number, address, age, phone number, etc, is also useful as a matter of practicality. For example, a password or other personal verifiable information can be entered and stored in database 170 as an account identifier, corresponding to other account information that is required to process a ticket purchase. On subsequent ticket purchases, a user can enter a password or other personal verifiable information to automatically retrieve the stored account information from database 170 that is necessary to process a ticket purchase. In the present embodiment, personal verifiable information is entered in password fields 460 in response to prompts requesting that the user to enter a password and a confirmation of the password.

Other account information that is necessary to purchase a ticket online includes credit card billing information 470, such as the cardholder's name, billing address, card number, and card expiration date. In the present embodiment, the user's ticket selections, personal verifiable information, and billing information are transmitted to the server system 110 when the user 310 selects the purchase ticket button 490. It should be appreciated that other means for ensuring the user 310 desires to proceed with purchasing a selected ticket can also be used. Upon receiving the billing information, the server system 110 opens a secure connection with a financial services system, such as a corresponding credit card company, to transact the purchase of the selected ticket(s). Methods and systems for completing a credit card transaction over the Internet are common and well understood by those skilled in the art.

Ticket menu 400 also provides a prompt and corresponding field 480 for a user 310 to enter an email address. This is useful because it enables a user 310 to receive an email receipt or confirmation of the ticket purchase. In an alternative embodiment, the ticket menu 400 allows the user 310 to enter a facsimile number to receive a facsimile confirmation of the ticket purchase.

In yet another embodiment, ticket menu 400 includes a prompt for the user 310 to enter or select the advertisement, if any, that directed the user to purchase the ticket. When a user 310 is automatically navigated to the ticket menu 400 from another Web page or banner then the ticket menu system automatically recognizes the corresponding Web page or banner advertisement.

After the ticket is selected and purchased, step 346, then the server system 320 proceeds to generate a ticket of the invention. According to one method of the invention, the act of creating or generating a ticket is performed by ticket creation module 160. The components of ticket creation module 160 are shown and described in more detail in reference to FIG. 5.

User identification authenticator 510 verifies the identity of the ticket purchaser when a password or other personal verifiable information is entered by the user 310 and retrieves the corresponding account information, if any. In a preferred embodiment, user identification authenticator 510 retrieves a user's account information only after an account name and a correspondingly correct password are provided. For example, when user 310 enters a correct password and account name then user identification authenticator 510 accesses database 170 and retrieves the user's account and billing information. This facilitates the user's purchase of a ticket because user 310 does not have to reenter account and billing information a second time. If an account is not already established, then user identification authenticator 510 simply prompts the user 310 for appropriate account information, which is stored in database 170 and is accessed for future ticket purchases.

Payment verification 520 processes the purchase of the ticket with a financial services system 130, such as a credit card agency. If a user 310 is denied credit or if the ticket purchase cannot be completed for any other reason, payment verification 520 notifies the user 310 of the result. Payment verification 520 also adjusts the ticket purchase price to include service fees associated with purchasing the ticket online, and discounts associated with coupon codes or advertisements.

Random number generator 530 generates a random number that can be referenced to authenticate the ticket at a later time. In one embodiment, random number generator 530 generates a random six-digit number, although fewer or more digits can be used. It should be appreciated that the total number of unique random six-digit numbers is a function of what numbers are used (e.g. 0-9), whether the numbers are allowed to repeat (e.g. 777777), whether the numbers are alphanumeric (e.g. A88B9C), whether small case letters are used (e.g. 1aB2cD), and whether typographical symbols are used (e.g. 7/aB-80). The function of the random six-digit number is to help make the ticket unique. Even though it is possible for a random six-digit number to be generated more than once, it is unlikely according to the invention, particularly when there are only a limited number of tickets that are going to be produced and an appropriate scheme is chosen to generate a high quantity of unique six-digit numbers. If a random number is repeated, then random number generator 530 can generate a new random number that is unique, if desired, to ensure that each ticket has a unique random six-digit number.

Incremental counter 540 also helps ensure the ticket is unique. To do this, the incremental counter 540 keeps track of all the tickets that are purchased online for each event and assigns each ticket an incremental count number that is sequentially determined for each event. For example, in one embodiment, the first ticket of every event is assigned the number 1001, the second ticket is assigned the number 1002, etc.

The incremental count number and the random six-digit number are part of the authentication information 220 that is encoded in barcode format to ensure that no two tickets are the same, unless one is a counterfeit. The incremental count number and the random six-digit number are stored in database 170 with other ticket information.

The barcode generator 550 takes the incremental count number and the random six-digit number and formats them into barcodes, such as a Code 39 barcode 260 and PDF-417 barcode 250. The barcode generator 550 can format both numbers into a single barcode or split the numbers between two or more barcodes. The barcode generator can also embed other authentication information 220 within the barcodes 250, 260, such as a user's email address, zip-code, password, personal identification number, drivers license number, or any other personally verifiable information that can be confirmed by a user when redeeming the ticket for admission to an event. The barcode generator 550 can also embed advertising codes into the barcodes 250, 260 so that when a ticket is redeemed for admission, the particular advertisement will be recognized by the event to help determine the effectiveness of the advertisement.

Command processing 560 executes user requests, performs various general control functions, and coordinates the operation of other components. Command processing 560 also controls the generation of a ticket by ensuring the ticket comprises appropriate ticket information, authentication information and a counterfeit deterrent, if any. Once a ticket is generated, command processing 560 transfers an electronic image of the generated ticket to the user interface of the user computer system 120 along with a confirmation of the ticket purchase, step 350.

In one embodiment, the electronic image of the generated ticket comprises an image file, such as a gif, jpg, jpeg, tif, tiff, etc. This is useful for allowing the image of the ticket, including the barcodes, to be displayed on a user interface without requiring special barcode software, which would otherwise be required to recognize and display the barcode fonts.

In step 354, ticket information, including authentication information, which is printed on the ticket is stored in database 170. This can be done at any time during or after the ticket information is generated by mapping module 160. Step 354 can also include the act of storing a user's profile and personal verifiable information in database 170.

The user 310 finally receives an email confirmation of the ticket purchase in step 356. The email confirmation, which includes ticket event information and a unique authorization number, is one means for verifying that the ticket was actually purchased by the user. Next, in step 352, the user 310 prints the ticket from the user computer system 120. This is accomplished when the user 310 selects an appropriate print button from the ticket menu 400, if one is provided, or by performing a print function with the user computer system 120 after the ticket is displayed on the user interface of the user computer system 120. The ticket is displayed in electronic form on a user interface of the user computer system 120. The ticket can include additional counterfeit deterrents that prevent the electronic image of the ticket from being saved or from being printed more than once from the user computer system 120. Once the ticket is printed, the user 310 can present the ticket for admission at a corresponding event, step 358.

One useful feature of the invention is that it enables a ticket purchased online to be authenticated before the ticket is redeemed. The invention provides several methods for authenticating a ticket. One method includes the act of comparing authentication information 220 that is located on a printed ticket with the authentication information 220 that is stored in database 170. To do this, in step 360, an event computer system 330 accesses the authentication information 220 that is stored in database 170 by any appropriate means. Appropriate means can include an Internet network connection 150, a courier type connection 180, direct network connection, and any other type of connection that would enable event computer system 140 to obtain access to authentication information 220 in database 170. For example, event computer system 140 may access database 170 over a SSL Internet connection and download authentication information 220. Event computer system 140 can also receive a magnetic diskette that contains a copy of the authentication information 220 of database 170. Event computer system 140 can also receive email files from server system 110 containing authentication information 220. It should be appreciated that event computer system 330 can view downloaded authentication information 220 in each of these methods while being disconnected from the server system 110.

In another embodiment, the event computer system 140 does not download authentication information 220, but merely views authentication information 220 while simultaneously authenticating a ticket, in step 362, and while maintaining a network connection with the server system 110.

It should also be appreciated that it is possible for event computer system 140 to receive a print copy of the authentication information 220, which is subsequently scanned or read into the event computer system 140 or used as a tangible cross-reference to authenticate tickets as they are read by the event computer system 140.

In step 362 a ticket that is presented for redemption is authenticated before it is redeemed. Authenticating a ticket typically includes the act of comparing authentication information 220 located on the ticket with authentication information 220 stored in database 170. This can be accomplished, according to the methods described above, and in connection with any suitable barcode scanner, PDA, or computing device. For example, an operator at the ticketed event can scan or read authentication information that is located on a ticket with a common barcode scanner. The ticket authentication information can then be compared to authentication information, accessed from the server system database 170, which is stored in a PDA or computing device that is attached to the barcode scanner. According to this embodiment, an electronic comparison is automatically made between the ticket authentication information and the authentication information accessed from the database 170. It should be appreciated, however, that electronic comparison is not necessary according to the invention. For example, an operator can also make a visual comparison between the ticket authentication information and the authentication information accessed from database 170 to verify the authenticity of a ticket.

Authentication information can include an incremental count number, a random six-digit number, and personal verifiable information that is displayed on the ticket in a barcode format. Authentication information makes it difficult to impossible for a counterfeiter to generate a barcode containing the exact same numbers and personal verifiable information as contained on a valid ticket.

When a ticket is scanned or read, as part of the authentication process, the only tickets that are redeemed are those that contain authentication information 220 that matches a corresponding record of authentication information 220 stored in database 170. If for any reason more than one ticket is presented with the same authentication information, it indicates that one of the tickets must be counterfeit because each ticket is unique, as described above. If two identical tickets are presented, the ticket holders can be questioned to obtain evidence that authenticates only one of the tickets. For example, a ticket holder can be questioned regarding a password, email address, or personal identification number. It is unlikely that the counterfeiter will be able to provide the answers to these questions. If it becomes necessary, however, the ticket holder can also be required to present an I.D. to verify some of the personal verifiable information, such as an address zip code, age, name, address or other information that is embedded in the barcodes 250, 260. For events that are in high demand, the user can also be instructed to bring a copy of the email confirmation, which can help authenticate a ticket.

Once a ticket is authenticated, then it is redeemed for admission to the corresponding event, step 364.

Authentication information 220 is also useful for tracking fraudulent uses of the tickets that are purchased online. For example, if a counterfeit ticket is presented for admission at a ticketed event, the original ticket purchaser can be tracked by referencing the corresponding user profile and account information. An identified ticket purchaser can then be questioned help determine the origin of the counterfeit ticket. A user profile can also be modified at the database 170 to deny that user subsequent online purchases until a disputed matter is resolved.

It should be appreciated that the present invention provides a useful method for creating tickets online. In particular, the present invention enables a user to purchase uniquely identifiable tickets over the Internet at any time of the day or night. Tickets created according to the invention can also be authenticated and redeemed for admission to a ticketed event in a manner that preserves the integrity of online ticketing process by discouraging counterfeiting of the purchased tickets. Other advantages and benefits of the invention should be apparent from the disclosure that is provided herein.

The present invention may be embodied in other specific forms without departing from its spirit or essential characteristics. The described embodiments are to be considered in all respects only as illustrative and not restrictive.

What is claimed and desired to be secured by united states Letters Patent is:

1. In a server system that communicates with a remote computer system over a network, a method of interactively creating a ticket that is redeemable for admission at a ticketed event, the method comprising the acts of:
transmitting to the remote computer system a menu that comprises ticket information associated with at least one ticketed event, wherein the menu is displayed on the remote computer system;
receiving from the remote computer system user input that is entered at the remote computer system by a user selecting ticket information;
creating a ticket for admission to the ticketed event in response to the user input, the ticket comprising ticketed event information and ticket authentication information; and
transmitting an electronic image of the ticket to the remote computer system.

2. A method as defined in claim 1, wherein the method further comprises the act of storing a copy of ticket authentication information in a database of the server system.

3. A method as defined in claim 2, wherein the method further comprises the act of transmitting the ticket authentication information to an entity that redeems tickets for admission to the ticketed event.

4. A method as defined in claim 1, wherein the menu comprises ticket information associated with a plurality of ticketed events operated by a plurality of entities that redeem tickets for admission to the plurality of ticketed events.

5. A method as defined in claim 1, wherein the method further comprises the act of transmitting an email message to the user regarding the ticket and the ticketed event.

6. A method as defined in claim 5, wherein the method further comprises the act of printing a copy of the ticket at the remote computer system.

7. A method as defined in claim 6, wherein the ticket comprises a counterfeit deterrent that operates to prevent a redeemable ticket from being produced by the act of photocopying the printed ticket, such that the act of printing a copy of the ticket at the remote computer system includes the act of printing the counterfeit deterrent on the printed copy of the ticket.

8. A method as defined in claim 7, wherein the counterfeit deterrent includes a transparent image, such that a photocopy image of the counterfeit deterrent comprises a comprises a substantially opaque image.

9. A method as defined in claim 1, wherein the authentication information is included in at least one barcode on the ticket.

10. A method as defined in claim 9, wherein the authentication information comprises an event identification number.

11. A method as defined in claim 9, wherein the authentication information comprises an incremental count number.

12. A method as defined in claim 9, wherein the authentication information comprises a random number.

13. A method as defined in claim 9, wherein the authentication information comprises user input.

14. A method as defined in claim 9, wherein the at least one barcode comprises at least one of either a Code 39 barcode and a PDF-417 barcode.

15. A method as defined in claim 9, wherein the at least one barcode comprises a Code 39 barcode and a PDF-417 barcode.

16. In a computer system that communicates with a remote server system over a network, a method of interactively creating a ticket that is redeemable for admission at a ticket event, the method comprising the acts of:
receiving from the remote server system a menu that comprises ticket information associated with at least one ticketed event;
displaying the menu on a display of the computer system;
receiving user input that is entered by a user selecting ticket information;
transmitting the user input to the remote server system;
receiving from the remote server system an electronic image of a ticket that is created at the server system in response to the user input, the ticket comprising ticketed event information and ticket authentication information; and
printing a copy of the ticket on a tangible medium, wherein the printed ticket is redeemable for admission at the ticketed event.

17. A method as defined in claim 16, wherein the authentication information is included in at least one barcode on the ticket.

18. A method as defined in claim 17, wherein the at least one barcode comprises at least one of either a Code 39 barcode and a PDF-417 barcode.

19. A method as defined in claim 17, wherein the at least one barcode comprises a Code 39 barcode and a PDF-417 barcode.

20. A method as defined in claim 19, wherein the authentication information comprises at least one of an event identification number, an incremental count number, a random number, and user input.

21. A method as defined in claim 20, wherein the ticket further comprises a counterfeit deterrent, and wherein the counterfeit deterrent includes a transparent image, such that a photocopy image of the counterfeit deterrent comprises a substantially opaque image.

22. A method for redeeming a ticket that is interactively created at a remote server system in response to user input that is entered by a user at a user computer system, the method comprising the acts of:
at the user computer system, receiving over the Internet an electronic image of the ticket from the remote server system, the ticket comprising ticketed event information and ticket authentication information;
at the user computer system, printing a copy of the ticket on a tangible medium;
at an event computer system, reading the ticketed event information and ticket authentication information that is located on the ticket; and
upon determining that the ticketed event information and ticket authentication information is valid, redeeming the ticket for admission.

23. A method as defined in claim 22, wherein the method further comprises the act of receiving at the event computer system a copy of the ticket authentication information.

24. A method as defined in claim 23, wherein the copy of the ticket authentication information is stored in a database, such that the act of receiving the copy of the ticket authentication information comprises the act of accessing the database.

25. A method as defined in claim 24, wherein the database is connected to the remote server system, and wherein the act of accessing the database comprises the act of accessing the database over a network connection between the event computer system and the remote server system.

26. A method as defined in claim 24, wherein the database is connected only to the event computer system.

27. A method as defined in claim 24, wherein the act of determining that the ticket authentication information is valid, comprises the act of comparing ticket authentication information located on the ticket with the ticket authentication information accessed from the database.

28. A method as defined in claim 27, wherein ticket authentication information located on the ticket is contained in at least one of a Code 39 barcode and a PDF-417 barcode, and wherein the ticket authentication information comprises at least one of an event identification number, an incremental count number, a random number, and user input.

29. A method as defined in claim 29, wherein the act of determining that the ticket authentication information is valid, further comprises the act of comparing ticket authentication information with information provided by a user.

30. A method for authenticating a ticket that is generated at a remote server system in response to user input that is entered by a user at a user computer system, the method comprising the acts of:
at the user computer system, receiving over the Internet an electronic image of the ticket from the remote server system, the ticket comprising ticketed event information and ticket authentication information;
at the remote server system, storing a copy of the ticket authentication information in a remote server system database;
at the computer system, printing a copy of the ticket on a tangible medium;
at an event computer system operated by an entity that redeems tickets for admission to the event, accessing the ticket authentication information from the remote server system database;
at the event computer system, authenticating the ticket by matching the ticket authentication information on the ticket with the ticket authentication information that is accessed from the remote server system database; and
at the event computer system, redeeming the authenticated ticket for admission.

31. A method as defined in claim 30, wherein the act of accessing the ticket authentication information from the remote server system database comprises the act of receiving and loading a file from a disk, wherein the file comprises an electronic copy of the authentication information from the remote server system database.

32. A method as defined in claim 30, wherein the act of accessing the ticket authentication information from the remote server system database comprises the act of the event computer system accessing the remote server system database over a network connection between the event computer system and the remote server system.

33. A method as defined in claim 32, wherein the act of authenticating the ticket is performed while the event computer system is not engaged in network communication with the remote server system.

34. A method as defined in claim 33, wherein the act of determining that the ticket authentication information is valid, comprises the act of comparing ticket authentication information located on the ticket with the ticket authentication information accessed from the remote server system database.

35. A method as defined in claim 34, wherein ticket authentication information located on the ticket is contained in at least one of a Code 39 barcode and a PDF-417 barcode, and wherein the ticket authentication information comprises at least one of an event identification number, an incremental count number, a random number, and user input.
